(19) United States
(12) Patent Application Publication
(10) Pub. No.: US 2011/0001678 A1
(43) Pub. Date: Jan. 6, 2011

(54) Antenna Array

(75) Inventors: Cheng-Hsuan Hsu, Xin-Dian City (TW); Tsung-Wen Chiu, Xin-Dian City (TW); Fu-Ren Hsiao, Xin-Dian City (TW); Wen-His Lee, Xin-Dian City (TW)

Correspondence Address: SCHMEISER OLSEN & WATTS, 18 E UNIVERSITY DRIVE, SUITE # 101, MESA, AZ, 85201, US

(73) Assignee: ADVANCED CONNECTEK INC., Taipei County (TW)

(21) Appl. No.: 12/574,421

(22) Filed: Oct. 6, 2009

(30) Foreign Application Priority Data
Jul. 3, 2009 (TW) 098122559

(51) Int. Cl. H01Q 21/00; H01Q 1/48; H01Q 1/36

(52) U.S. Cl. 343/848; 343/700 MS; 343/893

(57) ABSTRACT

An antenna array comprises a substrate, radiation conductors, a first transmission network, a second transmission network, support members and a grounding plane. The radiation conductors are symmetrically arranged on the substrate. The first transmission network has a first feeder point and feed arms connected to the radiation conductors, wherein each feed arm of the first transmission network and the radiation conductor connected to the feed arm include an angle of 80-100 degrees. The second transmission network has a second feeder point and feed arms connected to the radiation conductors, wherein each feed arm of the second transmission network and the radiation conductor connected to the feed arm include an angle of 80-100 degrees. The radiation conductors, the first transmission network and the second transmission network are all disposed on an identical surface of the substrate. The support members are used to support the substrate and assembled to the grounding plane.

### BACKGROUND OF THE INVENTION

1. Field of the Invention

The present invention relates to an antenna array, particularly to an antenna array, whose radiation conductors and transmission networks are all arranged on an identical surface.

2. Description of the Related Art

In a conventional antenna array, identical radiation conductors are arranged to form an array with a spacing therebetween being 0.5-0.9 times the wavelength of the wireless signal. From a top view, the distribution of the radiation energy of an antenna array has a shape of “8”. In the two directions vertical to the line connecting two radiation conductors, the user receives two signals respectively from two antennae at the same time point. Therefore, the two signals are in phase. Further, the wireless electromagnetic wave can travel farthest in the two directions. When two in-phase signals are combined into a single signal, the intensity doubles. In other words, the signal has a gain of 3 dB.

Refer to FIG. 1 a perspective view of a “Dual Polarized Microstrip Patch Antenna Array for PCS Base Stations” disclosed in a U.S. Pat. No. 5,923,296, wherein a set of copper patches 3 and a set of copper patches 5 are alternately arranged on a printed circuit board 1 to form two antenna arrays polarized vertically to each other.

However, the volume of such a design is several times larger than that of the ordinary antenna array. Besides, the two antenna structures are asymmetric. Thus, the radiation patterns thereof have a great difference, and interference is likely to occur therebetween. Besides, such a design needs a very complicated network of feed-in transmission circuits. Thus, the signal will greatly attenuate, and interference between the transmission circuits increases.

### SUMMARY OF THE INVENTION

One objective of the present invention is to provide an antenna array, wherein each feed arm of the first and second transmission networks and the radiation conductor connected to the feed arm include an angle of 80-100 degrees, and wherein the feed junctions of the feed arms and the radiation conductors are arranged at appropriate positions to make the signals of two corresponding radiation conductors have a phase difference of 180 degrees, whereby is reduced the cross polarization and increased the antenna gain.

Another objective of the present invention is to provide an antenna array, wherein the first transmission network and the second transmission network are disposed on the same surface of the substrate, whereby is reduced the thickness of the antenna array, simplified the fabrication process, and decreased the fabrication difficulty, wherefore the antenna array of the present invention is suitable for mass production.

A further objective of the present invention is to provide an antenna array, wherein the first transmission network and the second transmission network are respectively arranged in different areas to prevent the transmission paths from overlapping and effectively inhibit the signal interference between the transmission networks, and wherein the circuits of the transmission networks are differently dimensioned to improve impedance matching and attain better operation frequency bands.

To achieve the abovementioned objectives, the present invention proposes an antenna array, which comprises a substrate, a plurality of radiation conductors, a first transmission network, a second transmission network, support members and a grounding plane. The radiation conductors are symmetrically arranged on the surface of the substrate. The first transmission network has a first feeder point and a plurality of feed arms connected to the radiation conductors, wherein each feed arm of the first transmission network and the radiation conductor connected to the feed arm include an angle of 80-100 degrees. The second transmission network has a second feeder point and a plurality of feed arms connected to the radiation conductors, wherein each feed arm of the second transmission network and the radiation conductor connected to the feed arm include an angle of 80-100 degrees. The radiation conductors, the first transmission network and the second transmission network are all disposed on an identical surface of the substrate. A feed junction exists between the feed arm and the radiation conductor. The support members are used to support the substrate and assembled to the upper surface of the grounding plane.

The present invention is characterized in that each feed arm and the radiation conductor connected to the feed arm include an angle of 80-100 degrees. In a first embodiment, each feed arm of the first and second transmission networks and the radiation conductor connected to the feed arm include an angle of 90 degrees. There are feed junctions between the first transmission network and the radiation conductors. There are also feed junctions between the second transmission network and the radiation conductors. The feed junctions are arranged at appropriate positions. Thereby, the radiation conductors will generate two sets of signals vertical to each other, and the signals of two corresponding radiation conductors have a phase difference of 180 degrees. Thus is reduced the cross polarization of the antenna array and increased the gain of the antenna system. The present invention is also characterized in that the radiation conductors, the first transmission network and the second transmission network are all disposed on the same surface of the substrate. Therefore, the thickness of the antenna array is reduced, the fabrication process is simplified, and the fabrication difficult is decreased. Thus, the present invention is suitable for mass production. The present invention is further characterized in that the first transmission network and the second transmission network do not overlap. Therefore, the present invention can effectively inhibit the signal interference between the transmission networks. Besides, the circuits of the transmission networks are differently dimensioned to improve the impedance matching of the antenna system and attain better operation frequency bands.

Below, the embodiments are described in detail to make easily understood the technical contents of the present invention.

### BRIEF DESCRIPTION OF THE DRAWINGS

FIG. 1 is a perspective view schematically showing a “Dual Polarized Microstrip Patch Antenna Array for PCS Base Stations” disclosed in a U.S. Pat. No. 5,923,296;

FIG. 2 is a top view schematically showing an antenna array according to a first embodiment of the present invention;

FIG. 3 is a side view schematically showing an antenna array according to the first embodiment of the present invention;

FIG. 4 is a diagram showing the measurement result of the return loss of the first transmission network according to the first embodiment of the present invention;

FIG. 5 is a diagram showing the measurement result of the return loss of the second transmission network according to the first embodiment of the present invention;

FIG. 6 is a diagram showing the measurement result of the radiation pattern of the first transmission network according to the first embodiment of the present invention;

FIG. 7 is a diagram showing the measurement result of the radiation pattern of the second transmission network according to the first embodiment of the present invention;

FIG. 8 is a top view schematically showing an antenna array according to a second embodiment of the present invention; and

FIG. 9 is a perspective view schematically showing that an antenna array according to the second embodiment of the present invention is applied to a wireless transmission device.

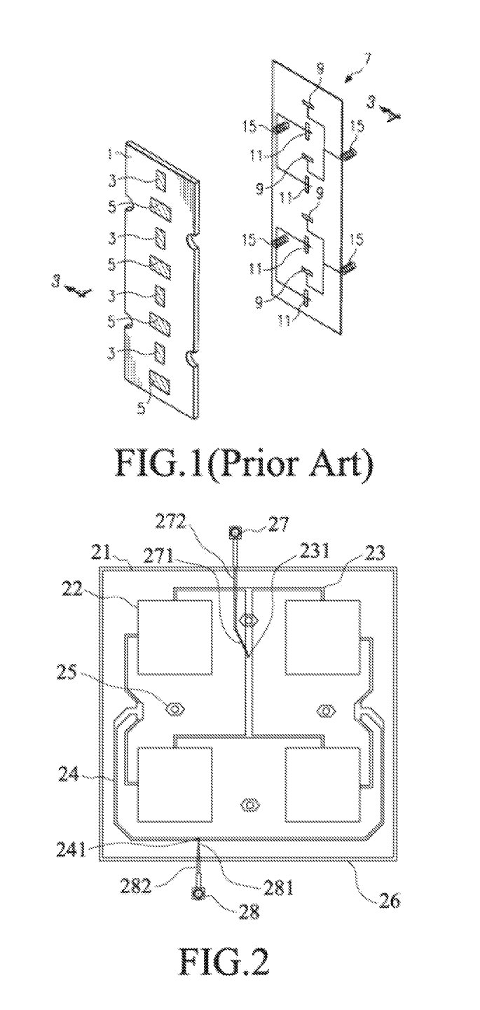

### DETAILED DESCRIPTION OF THE INVENTION

Refer to FIG. 2 a top view of an antenna array according to a first embodiment of the present invention. The antenna array of the present invention comprises a substrate 21, a plurality of radiation conductors 22, a first transmission network 23, a second transmission network 24, support members 25, and a grounding plane 26. The first transmission network 23 has a common first feeder point 231. The second transmission network 24 has a common second feeder point 241.

The radiation conductors 22 are symmetrically arranged on the substrate 21. The first transmission network 23 is connected to every radiation conductor 22. The second transmission network 24 is also connected to every radiation conductor 22. In the first embodiment, the radiation conductors 22, the first transmission network 23, and the second transmission network 24 are all disposed on the same surface of the substrate 21, and the first transmission network 23 and the second transmission network 24 do not overlap. The feed arms of the first transmission network 23 and second transmission network 24 are connected to the radiation conductors via feed junctions. Each feed arm and the radiation conductor 22 connected to the feed arm include an angle of 90 degrees. The feed junctions are arranged at appropriate positions of the radiation conductor 22, whereby the signals of two corresponding radiation conductors 22 have a phase difference of 180 degrees. The circuits of the first transmission network 23 and the second transmission network 24 are differently dimensioned to adjust the impedance matching of the antenna array. The support members 25 are made of a non-metallic material and installed on the upper surface of the grounding plane 26 to support the substrate 21 arranged above the support members 25. The support members 25 form a gap between the substrate 21 and the grounding plane 26 lest the substrate 21 contact the grounding plane 26 and lest the transmission efficiency of signals be affected.

The antenna array of the present invention further comprises a first feeder cable 27 and a second feeder cable 28. The first feeder cable 27 includes a first central wire 271 connected to the first feeder point 231 and a first external wire 272 connected to the grounding plane 26. The second feeder cable 28 includes a second central wire 281 connected to the second feeder point 241 and a second external wire 282 connected to the grounding plane 26.

In the first embodiment, the substrate 21 is a rectangle having a length of about 170 mm and a width of about 140 mm. The radiation conductor 22 is a square having a length of about 45 mm. The path of the first transmission network 23 has a total length of about 295 mm. The path of the second transmission network 24 has a total length of about 550 mm. The support member 25 is made of a non-metallic material and has a cylindrical shape with a diameter of about 3 mm and a height of about 6 mm. The grounding plane 26 is a rectangle having a length of about 180 mm and a width of about 150 mm.

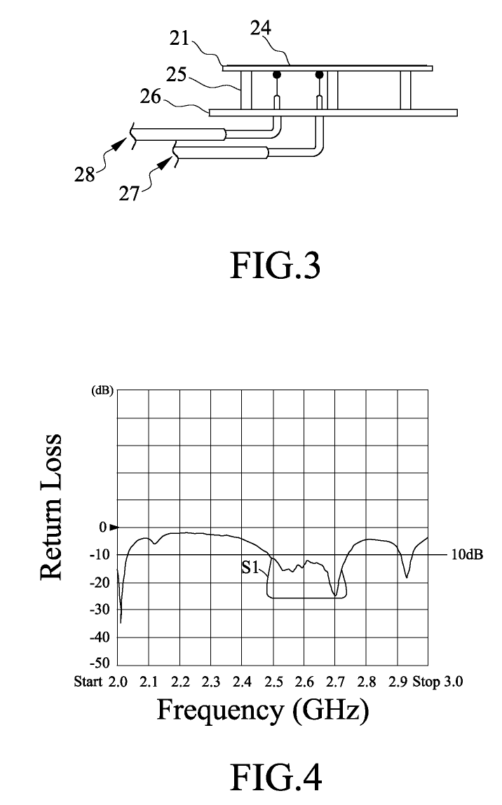

Refer to FIG. 2 and FIG. 3 at the same time, a side view of an antenna array according to the first embodiment of the present invention. Firstly, the radiation conductors 22, the first transmission network 23 and the second transmission network 24 are installed on the same surface of the substrate 21. Next, the support members 25 are used to support the bottom surface of the substrate 21. Then, the support members 25 are assembled to the upper surface of the grounding plane 26. In the present invention, the sizes of the substrate 21 and the grounding plane 26 are obviously reduced. Further, the structure is greatly simplified. Therefore, the present invention is suitable for mass production.

Refer to FIG. 4 a diagram showing the measurement result of the return loss of the first transmission network according to the first embodiment of the present invention, wherein the horizontal axis denotes the frequency and the vertical axis denotes dB. When an operation frequency band S1 of the first transmission network is defined to be the frequency range having a return loss greater than 10 dB, the operation frequency band S1 is between 2.5 and 2.75 GHz, which covers the frequency band of the Wimax system.

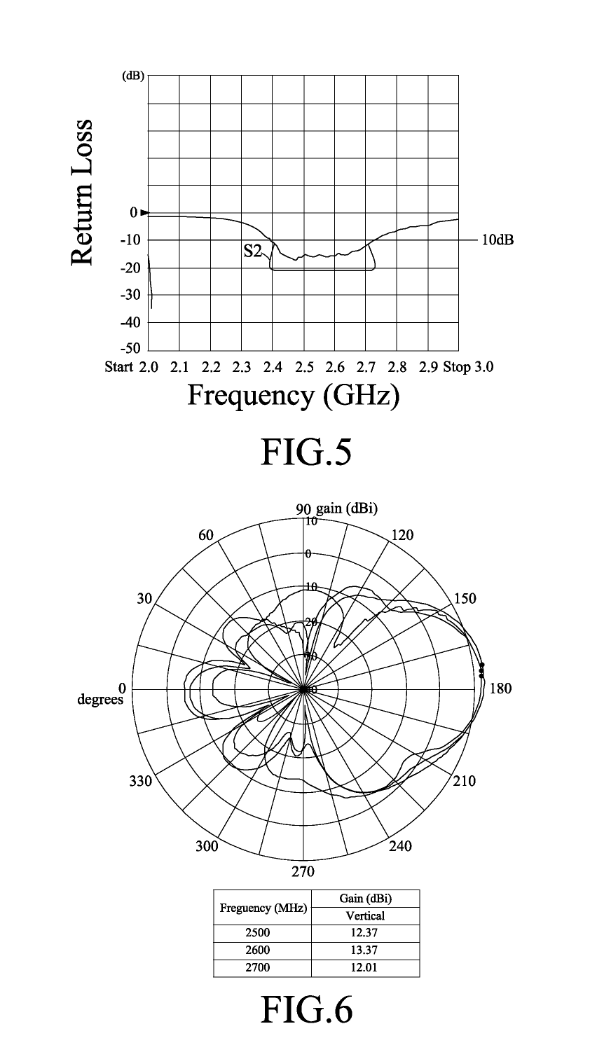

Refer to FIG. 5 a diagram showing the measurement result of the return loss of the second transmission network according to the first embodiment of the present invention, wherein the horizontal axis denotes the frequency and the vertical axis denotes dB. When an operation frequency band S2 of the second transmission network is defined to be the frequency range having a return loss greater than 10 dB, the operation frequency band S2 is between 2.4 and 2.7 GHz, which also covers the frequency band of the Wimax system. FIG. 4 and FIG. 5 show that the operation frequency bands of the antenna system of the present invention have met the requirement of the antenna design.

Refer to FIG. 6 a diagram showing the measurement result of the radiation pattern of the first transmission network according to the first embodiment of the present invention, wherein the central frequency of the radiation pattern of the antenna system ranges from 2500 to 2700 MHz. FIG. 6 shows that the maximum peak gains are all over 12.01 dBi.

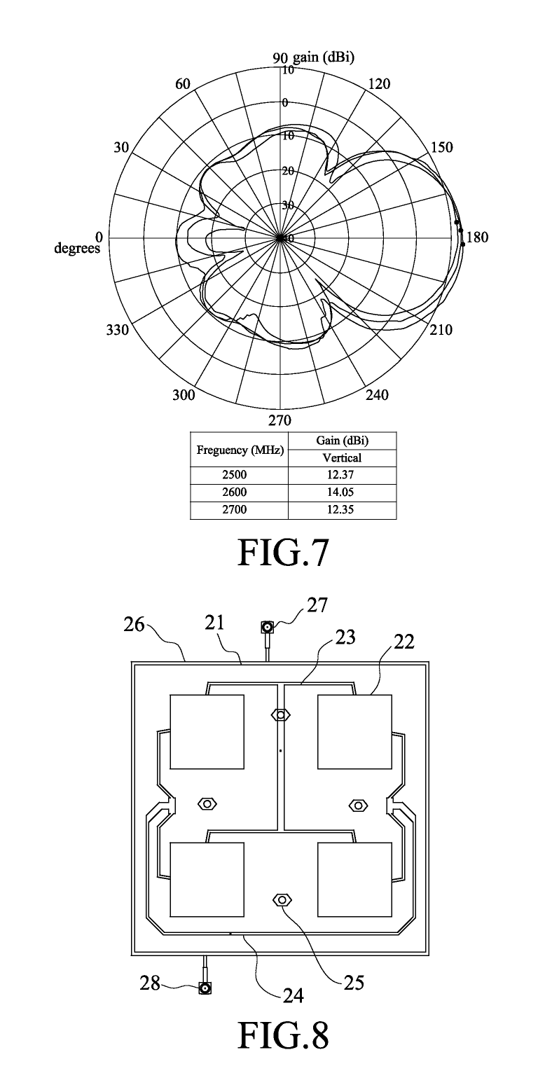

Refer to FIG. 7 a diagram showing the measurement result of the radiation pattern of the second transmission network according to the first embodiment of the present invention, wherein the central frequency of the radiation pattern of the antenna system ranges from 2500 to 2700 MHz. FIG. 7 shows that the maximum peak gains are all over 12.35 dBi. FIG. 6 and FIG. 7 show that the maximum peak gains of the radiation pattern of the present invention is obviously increased. Therefore, the present invention can reduce the interference on the radiation pattern and achieve a higher gain.

Refer to FIG. 8 a top view of a front side of an antenna array according to a second embodiment of the present invention. The second embodiment is basically similar to the first embodiment except each feed arm and the radiation conductor 22 connected to the feed arm include an angle of 80 degrees in the second embodiment. Similarly, the feed junctions of the feed arms and the radiation conductors 22 are arranged at appropriate positions of the radiation conductors 22 to make the signals of two corresponding radiation conductors 22 have a phase difference of 180 degrees in the second embodiment. No matter how many radiation conductors an antenna system adopts, the persons skilled in the art should be able to design the feed junctions to reduce cross polarization and increase the antenna gain according to the spirit of the present invention. Therefore, it must be stressed herein that all the modifications and variations according to the spirit of the present invention should be also included within the scope of the present invention.

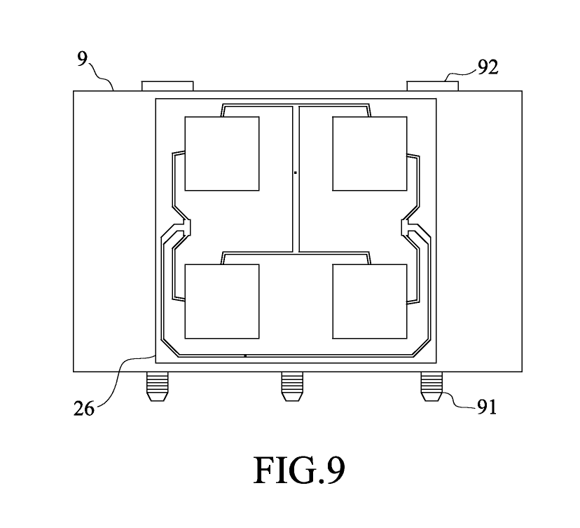

Refer to FIG. 9 a perspective view schematically showing an antenna array according to the second embodiment of the present invention is applied to a wireless transmission device. The antenna array of the present invention is accommodated inside a housing of a wireless transmission device 9. The antenna array is securely assembled to the transmission device 9 with the sustaining elements of the grounding plane 26. The antenna array is connected to external devices via a signal connector 91 and a socket 92 of the transmission device 9 to transmit and receive wireless signals.

The present invention possesses utility, novelty and non-obviousness. Therefore, the present invention meets the conditions for a patent. It should be noted herein that the embodiments described above are only to exemplify the present invention but not to limit the scope of the present invention. Any equivalent modification or variation according to the spirit of the present invention is to be also included within the scope of the present invention.

What is claimed is:

1. An antenna array comprising
a substrate;
a plurality of radiation conductors symmetrically arranged on said substrate;
a first transmission network having a first feeder point and a plurality of feed arms connected to said radiation conductors, wherein each said feed arm of said first transmission network and said radiation conductor connected to said feed arm include an angle of 80-100 degrees;
a second transmission network having a second feeder point and a plurality of feed arms connected to said radiation conductors, wherein said radiation conductors, said first transmission network and said second transmission network are all disposed on an identical surface of said substrate, and wherein each said feed arm of said second transmission network and said radiation conductor connected to said feed arm include an angle of 80-100 degrees;
a support members supporting said substrate; and
a grounding plane where said support members are assembled.

2. The antenna array according to claim 1 further comprising a first feeder cable, which includes
a first central wire connected to said first feeder point; and
a first external wire connected to said grounding plane.

3. The antenna array according to claim 1 further comprising a second feeder cable, which includes
a second central wire connected to said second feeder point; and
a second external wire connected to said grounding plane.

4. The antenna array according to claim 1, wherein said first transmission network and said second transmission network do not overlap.

5. The antenna array according to claim 1, wherein circuits of said first transmission network and said second transmission network respectively have different dimensions.

6. The antenna array according to claim 1, wherein said support members are made of a non-metallic material.

7. The antenna array according to claim 1, wherein a gap exists between said substrate and said grounding plane.
